(19) United States
(12) Patent Application Publication
(10) Pub. No.: US 2010/0088967 A1
(43) Pub. Date: Apr. 15, 2010

(54) SEALING GATE FOR STRIPS

(76) Inventors: Lutz Kümmel, Juchen (DE); Andreas Gramer, Solingen (DE); Holger Behrens, Erkrath (DE); Matthias Kretschmer, Koln (DE); Ralf-Hartmut Sohl, Solingen (DE); Peter Kock, Oberhausen (DE)

Correspondence Address: K.F. ROSS P.C., 5683 RIVERDALE AVENUE, SUITE 203 BOX 900, BRONX, NY, 10471-0900, US

(21) Appl. No.: 12/446,984

(22) PCT Filed: Oct. 12, 2007
(86) PCT No.: PCT/EP07/08890

§ 371 Date: Apr. 24, 2009

(30) Foreign Application Priority Data
Oct. 27, 2006 (DE) 10 2006 051 395.9
Feb. 28, 2007 (DE) 10 2007 009 710.9

(51) Int. Cl. E06B 7/24; E06B 7/16

(52) U.S. Cl. 49/484.1; 49/495.1

(57) ABSTRACT

The invention relates to a sealing gate (1) for strips for sealing a first chamber (2) in relation to a second chamber (3), a strip (4), in particular a metal strip, passing through both chambers (2, 3) and at least one sealing element (5) being provided for sealing the chambers (2, 3). The aim of the invention is to achieve an effective sealing action. To achieve this, the sealing element (5) has at least two gate elements (6, 7, 8, 9) that can be displaced in relation to one another and that have at least one sealing surface (10, 11, 12, 13), which is adapted to the edge contour of the strip (4) to be sealed.

The invention relates to a strip-sealing gate for sealing a first chamber with respect to a second chamber through both of which a strip, in particular a metal strip, passes, at least one seal being provided for sealing the chambers.

In the manufacture and processing of a metal strip, in particular steel strip, it is occasionally necessary to carry out processes in a reduced-pressure environment (vacuum process). To this end, the strip is fed into a chamber that has a reduced pressure relative to ambient pressure. For continuous processing, strip-sealing gates of the above-described type are necessary that seal against the strip between the chambers at different pressures. Thus, the sealing gates are primarily used to maintain a pressure differential between two strip treatment zones.

Standard strip-sealing gates are known from DE 44 18 383 and DE 199 60 751, for example. These documents describe how at a gate stage two sealing rollers lie and seal against the strip, a first sealing roller bearing on the upper face of the strip and a second sealing roller bearing on the lower face.

Such strip-sealing gates are generally used for products having a width-to-thickness ratio that is much greater than 1. They may also be used to relatively seal chambers in which different media are used for strip treatment.

Because of the bearings necessary for the rollers, sealing using rollers is relatively complicated and therefore costly. This is especially true when the width and/or thickness of the strip to be sealed are changed for workpiece-related reasons. Adapting the strip-sealing gate to strips of various widths and thicknesses is complicated. In addition, the adjustment sometimes adversely affects the quality of the seal.

The object of the present invention, therefore, is to refine a strip-sealing gate of the above-described type in such a way that an improvement may be achieved. Thus, the sealing gate should have an improved sealing effect, and should be easily adjustable to strips of various widths and thicknesses.

This object is achieved according to the invention by the fact that the sealing means has at least two gate elements that are displaceable relative to one another and that have at least one sealing surface conforming to a respective edge of the strip to be sealed.

At least two of the gate elements are plates, parallel, and lie against one another. The individual gate plates contact one another in a sealing manner. At least some of the gate elements may be connected to actuators in order to move a gate element in a direction perpendicular to the travel direction of the strip.

Thus, according to the invention multiple gate elements are moved toward the strip in such a way that an aperture that conforms to the shape of the strip is formed for it. To this end, the gate elements each have at least one sealing face that corresponds to a respective edge of the strip.

In one preferred embodiment, two gate plates that are displaceable relative to one another are provided, each having a rectangular opening for the strip to pass through. Thus, any given rectangular aperture may be formed for the strip by corresponding shifting of the gate plates.

In one alternative embodiment, two gate plates that are displaceable relative to each other each have two relatively perpendicular sealing edges. In cooperation with these gate plates a rectangular aperture may likewise be provided for the strip that conforms precisely to the cross-sectional shape of the strip.

In another alternative embodiment of the invention, four gate plates that are displaceable relative to one another are provided, each having a single straight sealing edge. According to this embodiment, a total of four gate sections may be combined to provide a rectangular aperture for the strip.

One of the gate elements may also be a roller.

At least one of the gate elements may be pressed with its sealing surface against the strip surface by at least one spring.

For precise guiding of the strip, in one refinement at least one guide roller is provided that bears on the respective strip edge and guides the strip relative to the strip-sealing gate.

In one specialized embodiment of the invention, at least one gate plate is provided with means for adjusting the effective height or effective width. The means for adjusting the effective height or effective width is preferably formed by two gate sections that bear on each other at contact faces extending at an acute angle to the travel direction of the strip; at least one of the sections may be shifted in the travel direction of the strip by use of respective actuator.

To quickly and easily replace a worn gate with a new gate having a new sealing surface, it has proven useful for a means to be provided that can insert a gate plate into or withdraw it from the sealing region transverse to the travel direction of the strip.

For stabilization, the strip may be guided over two rollers in the travel direction in such a way that the strip is deflected twice, upstream and downstream of the gate elements.

To produce higher pressure differentials, it has proven useful to provide multiple sealing gate stages one after the other in the travel direction of the strip.

The strip-sealing gate is preferably used to seal a first chamber at a first pressure with respect to a second chamber at a second pressure that is different from the first pressure. However, the strip-sealing gate may also be used with chambers at equal pressure when various media must be sealed with respect to one another in the chambers; thus, in this case the strip-sealing gate is used to seal a first chamber containing a first process medium with respect to a second chamber containing a second process medium that is different from the first process medium.

Embodiments of the invention are shown in the figures:

FIG. 1 shows the important parts of a strip-sealing gate in the travel direction of the strip to be sealed;

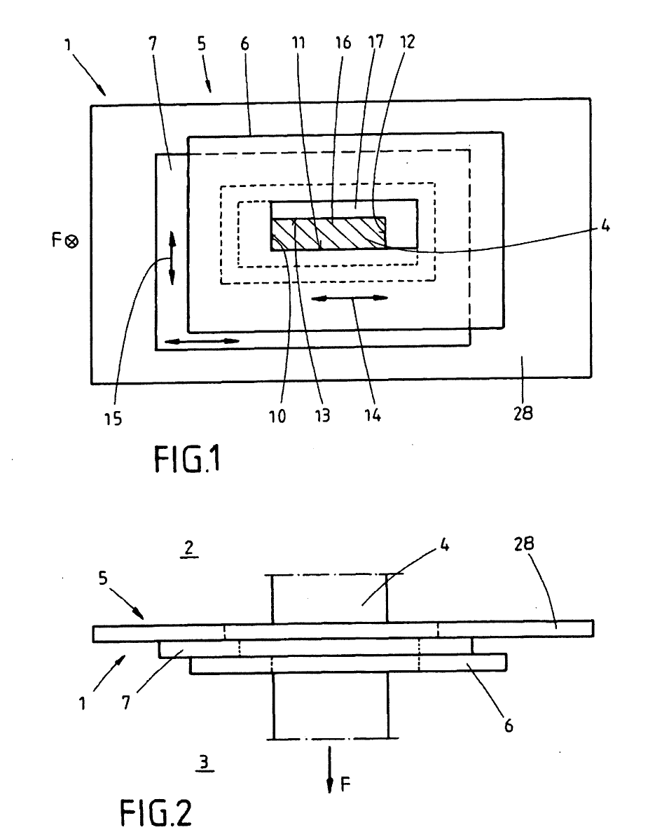

FIG. 2 is a top view of the strip-sealing gate corresponding to FIG. 1;

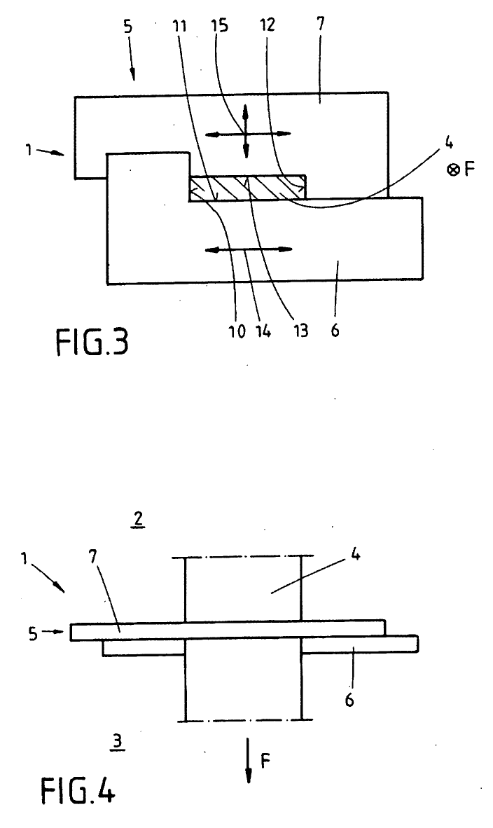

FIG. 3 shows a first alternative embodiment of the invention in a view like FIG. 1;

FIG. 4 is a top view of the strip-sealing gate corresponding to FIG. 3;

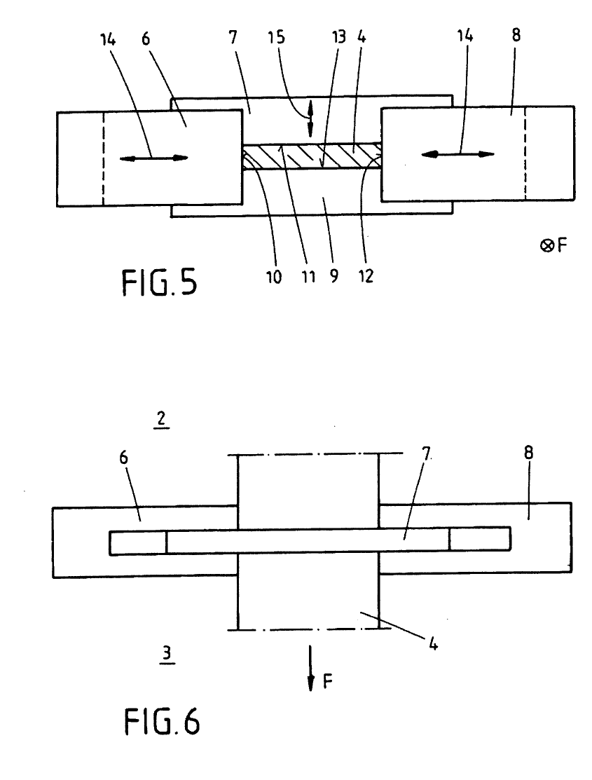

FIG. 5 shows a second alternative embodiment of the invention in a view like FIG. 1;

FIG. 6 is a top view of the strip-sealing gate corresponding to FIG. 5;

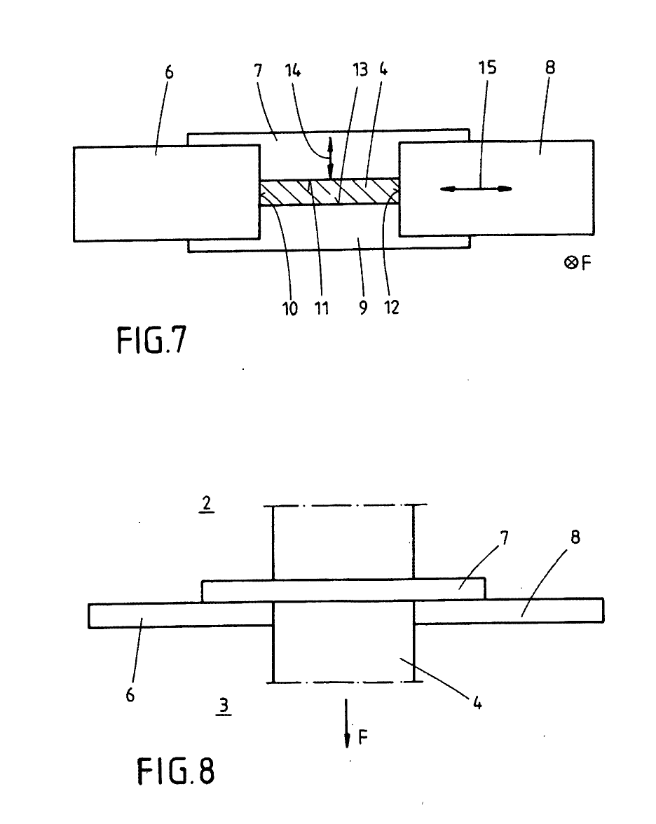

FIG. 7 shows a third alternative embodiment of the invention in a view like FIG. 1;

FIG. 8 is a top view of the strip-sealing gate corresponding to FIG. 7;

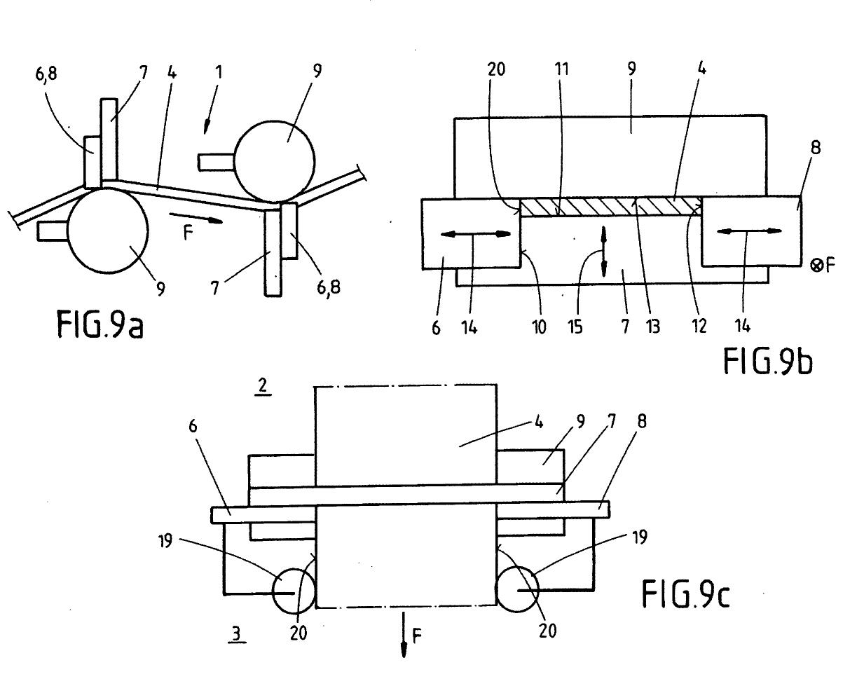

FIG. 9a shows a strip-sealing gate having two sealing gate stages, viewed in a direction transverse to the travel direction of the strip;

FIG. 9b shows the view corresponding to FIG. 9a, viewed in the travel direction of the strip;

FIG. 9c is a top view corresponding to FIG. 9a;

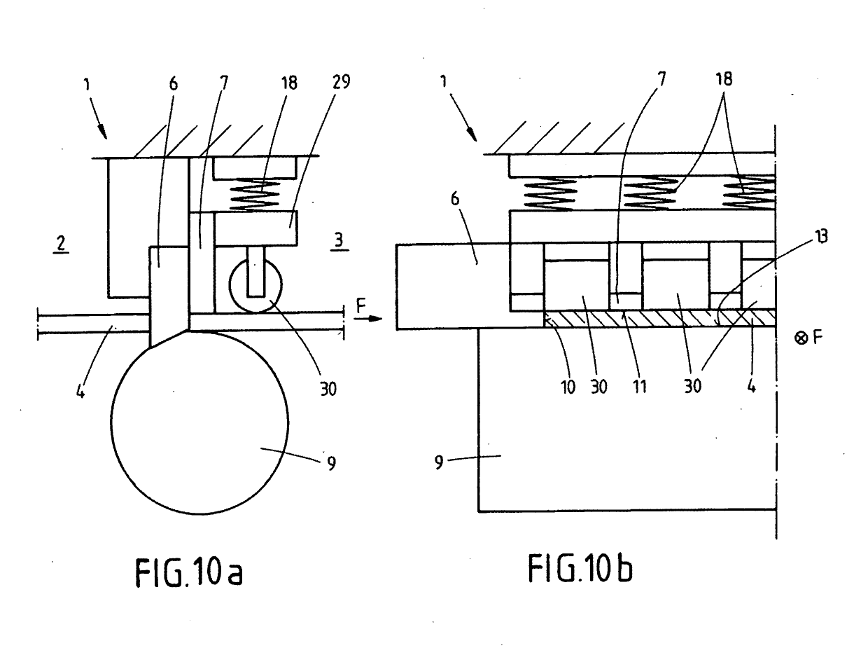

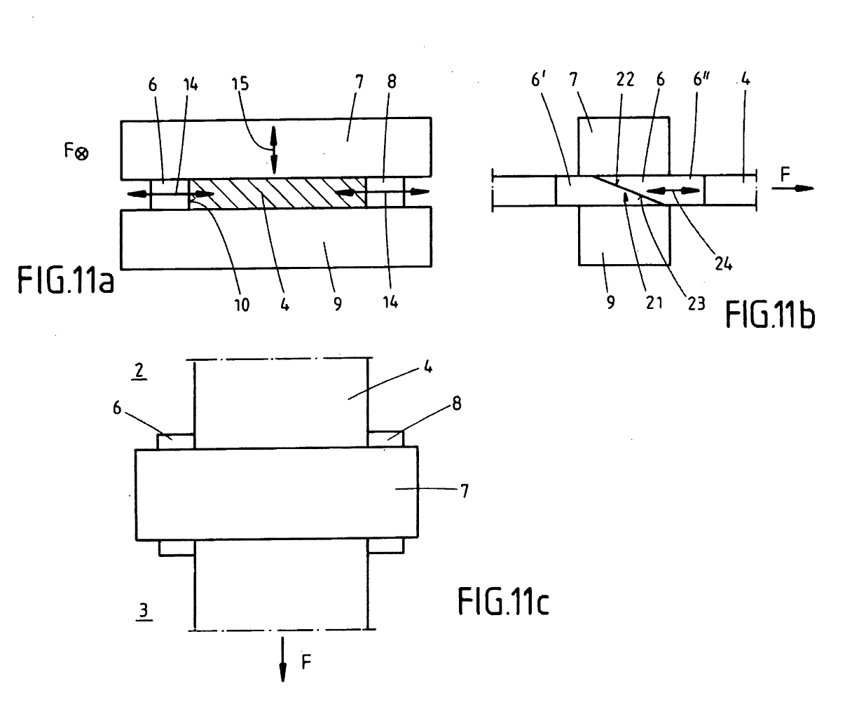

FIG. 10a shows an alternative embodiment of the strip-sealing gate, viewed in a direction transverse to the travel direction of the strip;

FIG. 10b shows the view of FIG. 10a but in the travel direction of the strip;

FIG. 11a shows another alternative embodiment of the strip-sealing gate, viewed in the travel direction of the strip;

FIG. 11b shows the view of FIG. 11a but in the direction transverse to the travel direction of the strip;

FIG. 11c shows the view of FIG. 11a in top view;

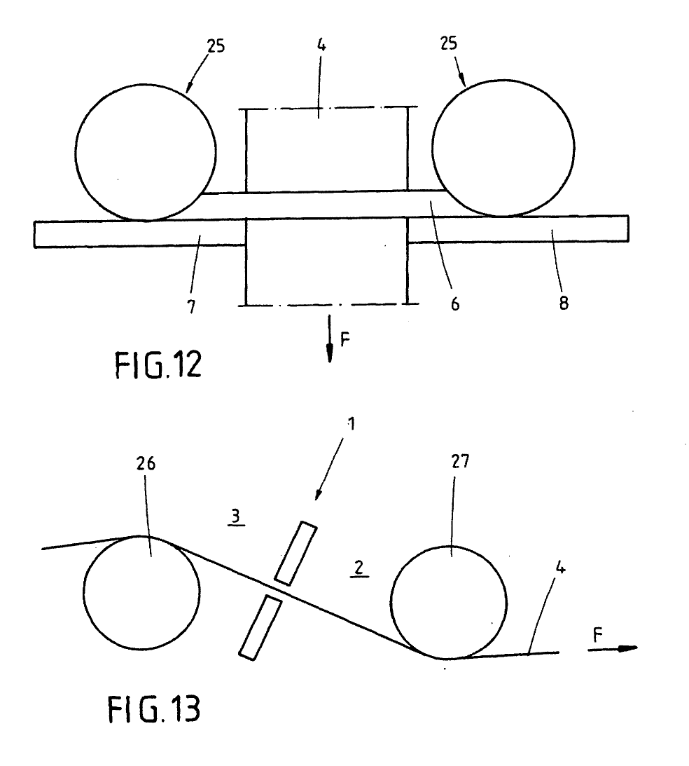

FIG. 12 shows a strip-sealing gate having means for replacing a gate plate; and

FIG. 13 shows a strip-sealing gate having upstream and downstream rollers for deflection of the strip to be sealed.

FIGS. 1 and 2 show a strip-sealing gate 1 that seals a first chamber 2 with respect to a second chamber 3. There is a pressure differential between the two chambers 2 and 3 that in order to be maintained requires the strip-sealing gate 1. The strip-sealing gate 1 allows continuous travel of a strip 4 through the strip-sealing gate 1 in the direction F.

Sealing means 5 is provided for sealing the strip 4. The sealing means 5 is composed primarily of two gate plates 6 and 7 having respective rectangular openings 16 and 17. The dimensions of the rectangular openings 16 and 17 are selected such that the width and the height are greater than the maximum width and height of the strip 4 to be sealed.

The gate plate 6 has two sealing surfaces 10 and 11, and the gate plate 7 has two sealing surfaces 12 and 13. As shown in FIG. 2, the two gate plates 6 and 7 make sealing contact with one another. The one gate plate 7 in turn contacts a chamber partition plate 28.

Shown only in a schematic fashion in FIG. 1 are actuators 14 and 15 that are used to displace the gate plates 6 and 7 in the plane of their plates. This occurs until the respective sealing surfaces 10, 11, 12, 13 lie against the strip 4, thereby sealing the strip 4 between the chambers 2 and 3.

Thus, the sealing occurs by a complimentary-shape contact region between the gates 6 and 7 and the strip 4. To adjust to a strip 4 that is to be sealed at a given moment, the gate plates 6 and 7 are moved toward the strip 4 according to the width and thickness of the strip 4. In a manner not shown, the gate plates 6 and 7 may be positioned by additional guides (guide rollers, for example) that fit the contour of the strip. The sealing of gate plates 6 and 7 with respect to one another is achieved via flat contact elements, i.e. separate seals, in particular sealing surfaces (not shown). The sealing of gate plates 6 and 7 with respect to the chamber partition 28 is likewise achieved via contact or seals (sealing surfaces).

An embodiment of the invention that is an alternative to that of FIGS. 1 and 2 is shown in FIGS. 3 and 4. Once again two gate plates 6 and 7 are present, except that here each of the gate plates has a cutout that defines the two mutually perpendicular sealing surfaces 10 and 11 (for gate plate 6) and 12 and 13 (for gate plate 7). As in FIGS. 1 and 2, here as well the two gate plates 6 and 7 are moved by actuators 14 and 15 in such a way that overall, a aperture for the strip 4 is provided that corresponds exactly to the cross-sectional shape of the strip 4.

In a further alternative embodiment according to FIGS. 5 and 6, four gate plates 6, 7, 8, and 9 are provided, all (except for the stationary gate plate 9) being moved by actuators 14 and 15 into a position in which their respective sealing surfaces 10, 11, 12, 13 define for the strip 4 the aperture that once again corresponds exactly to the cross-sectional shape of the strip 4.

As shown in the top view in FIG. 6, the two gate plates 6 and 8 are U-shaped; gate plates 7 and 9 are inserted into the resulting space between the two legs of these U-shaped structures.

FIGS. 7 and 8 show a further alternative embodiment of the sealing means, having four gate plates 6, 7, 8, and 9.

FIGS. 9a, 9b, and 9c show various views of a strip-sealing gate 1 having two sealing gate stages spaced apart in the travel direction F. One of the gate elements, namely, gate element 9, is designed as a roller in the present case. The roller 9 cooperates with three gate plates 6, 7, 8 in order to define the rectangular aperture for the strip 4 in the manner described.

FIG. 9c shows two guide rollers 19 positioned on the sides of the strip 4 that contact the strip edge 20 and thus center the strip 4 relative to the sealing means. According to this figure, the guide rollers 19 are stationarily mounted on the gate plates. In this manner the gate plates 6 and 7 are aligned to the strip edge position at any given moment.

However, the guide rollers 19 may also be stationarily attached at the strip-sealing gate or the base frame thereof, and guide the strip into the center of the strip-sealing gate.

Although both variants are possible, the latter is advantageous in that the strip is held in the center (strip center regulation), so that the gate need be adjusted for only small fluctuations. The forces that occur are smaller than for the first approach.

As shown in FIG. 9a, for better strip guiding the strip is partially wound through the rollers 9, thus allowing transverse bends or unevenness to be suppressed.

Here as well, the gate plates may be positioned by additional guides that conform to the contour of the strip.

FIGS. 10a and 10b show that the gate plates (in the present case shown for gate plate 7) may be spring-biased toward the respective strip faces by springs 18 in order to increase the degree of sealing. A crossbar 29 is spring-tensioned by springs 18, the crossbar 29 carrying the gate plate 7. A plurality of rollers 30 space the crossbar 29 a defined distance from the strip surface, thereby also defining the position of the gate plate 7. The crossbar 29 conforms to the contour and/or thickness of the strip at any given moment as a result of the biasing of the springs 18. The gate plate 7 follows the crossbar 29. In this manner it is possible to reduce wear and thus increase the service life of the sealing surface 11 for the gate plate 7.

The width of the strip is sealed by laterally displaceable gates.

FIGS. 11a, 11b, and 11c show an embodiment of the invention in which means 21 is provided for setting the effective height and effective width of a gate plate. As shown in the figures, in this case the gate 6 is of two-part design, i.e. has a first gate section 6′ and a second gate section 6″. As shown in FIG. 11 b, the two sections 6′ and 6″ have a sectional design that defines a small acute angle relative to the travel direction F; i.e. contact surfaces 22 and 23 result at which sections 6′, 6″ bear on each other. In addition, an actuator 24 is schematically indicated that can move the section 6″ relative to the other section 6′ in the travel direction F. As a result of the oblique slope of the contact surfaces 22 and 23 the effective height of gate 6 is changed so that it may be adjusted to the desired height. It is possible to adjust the gate 6 to the thickness of the strip 4.

FIG. 12 shows means 25 for replacing a gate plate 6 during continuous operation. The aim of this embodiment of the invention is replacement of the seal while the process is in operation, i.e. to minimize down times when a gate plate must be replaced due to wear. The gate plate with the worn sealing surface may be laterally withdrawn from the working region of the strip-sealing gate. A new gate plate may be inserted on the other side. The replacement may be carried out in particular when there is a pressure differential between chambers 2 and 3. Thus, continuous replacement of the gate plate as well as discontinuous replacement, if needed, are possible. In principle, the described replacement means may be used for all gate plates.

FIG. 13 shows the manner in which strip stabilization may be achieved in the region of the strip-sealing gate 1 by strip deflection. The strip 4 is deflected twice by the two rollers 26 and 27. The strip is thus pulled in one plane and is also stabilized between the rollers as a result of bending. The formation of visible unevenness and transverse bends is reduced. This results in reduced wear at the seals and reduced leakage.

The deflection rollers 26 and 27 may also be used for regulating the position of the strip. By regulating the strip position, the strip 4 may also be moved in a targeted manner (swarming). In this manner the wear on the sealing surfaces of the gate plates may be evened out or minimized over the width of the strip. The sealing surfaces at the strip edges are thus synchronously followed.

This results in a simple and economical design for the strip-sealing gate that has good sealing characteristics due to a positive fit. The gate plates provided according to the invention are positioned so as to seal with respect to one another, and are displaced so that an aperture is produced that corresponds to the cross-sectional shape of the strip.

The adjustment to new strip dimensions may be made in two ways: active adjustment that involves a controlled change of the setting of the gate plates, and passive adjustment, in which the strip is pressed into the required position by the sealing faces of the gate plates.

By using the proposed approach, chambers at different pressures as well as chambers having the same pressure may be sealed with respect to one another, in chambers containing various process media, in particular process gases, but also liquids. If lateral rollers are provided that contact the strip edge, good lateral guiding of the strip may be achieved. Rollers that run on the strip surface may be used to guide gate plates.

List of reference numerals

| | |
|---|---|
| 1 | Strip-sealing gate |
| 2 | First chamber |
| 3 | Second chamber |
| 4 | Strip |
| 5 | Sealing means |
| 6 | Gate plate |
| 6′ | Gate section |
| 6″ | Gate section |
| 7 | Gate plate |
| 8 | Gate plate |
| 9 | Gate plate |
| 10 | Sealing surface |
| 11 | Sealing surface |
| 12 | Sealing surface |
| 13 | Sealing surface |
| 14 | Actuator |
| 15 | Actuator |
| 16 | Rectangular opening |
| 17 | Rectangular opening |
| 18 | Spring |
| 19 | Guide roller |
| 20 | Strip edge |
| 21 | Means for adapting the |
| | effective height or width |
| 22 | Contact surface |
| 23 | Contact surface |
| 24 | Actuator |
| 25 | Replacement means |
| 26 | Roller |
| 27 | Roller |
| 28 | Chamber partition |
| 29 | Crossbar |
| 30 | Roller |
| F | Travel direction |

1. A strip-sealing gate for sealing a first chamber with respect to a second chamber through which a strip, in particular a metal strip, passes, at least one seal being provided for sealing the chambers wherein the seal has at least two gate elements that are displaceable relative to one another and that each have at least one sealing surface conforming to a respective edge of the strip to be sealed.

2. The strip-sealing gate according to claim 1 wherein at least two of the gate elements are plates, parallel, and lie against one another.

3. The strip-sealing gate according to claim 1 wherein at least some of the gate elements are connected to actuators in order to move a gate element in a direction perpendicular to the travel direction of the strip.

4. The strip-sealing gate according to claim 2 wherein two gate plates that are displaceable relative to one another are provided and that each have a rectangular opening for the strip to pass through.

5. The strip-sealing gate according to claim 2 wherein two gate plates that are displaceable relative to one another are provided and that each have two mutually perpendicular sealing surfaces.

6. The strip-sealing gate according to claim 2 wherein there are four gate plates that are displaceable relative to one another and that each have a straight sealing surface.

7. The strip-sealing gate according to claim 1 wherein one of the gate elements is a roller.

8. The strip-sealing gate according to claim 1 wherein at least one of the gate elements is pressed with its sealing surface against a respective strip face by at least one spring.

9. The strip-sealing gate according to claim 1 wherein at least one guide roller is provided that engages a respective strip edge and guides the strip relative to the strip-sealing gate.

10. The strip-sealing gate according to claim 1 wherein at least one gate element is provided with means for adjusting its effective height or effective width.

11. The strip-sealing gate according to claim 10 wherein the means for adjusting the effective height or effective width has two gate sections that engage each other at contact faces extending at an acute angle to the travel direction of the strip, at least one of the sections being shiftable in the travel direction of the strip by a respective actuator.

12. The strip-sealing gate according to claim 1 wherein means is provided for inserting a gate plate into or withdrawing it from the sealing region transverse to the travel direction of the strip.

13. The strip-sealing gate according to claim 1 wherein the strip is guided over two rollers in the travel direction in such a way that the strip is deflected twice, upstream and downstream of the gate elements.

14. The strip-sealing gate according to claim 1 wherein multiple sealing gate stages are provided in succession in the travel direction of the strip.

15. The strip-sealing gate according to claim 1 wherein the strip-sealing gate is used to seal a first chamber at a first pressure with respect to a second chamber at a second pressure that is different from the first pressure.

16. The strip-sealing gate according to claim 1 wherein the strip-sealing gate is used to seal a first chamber containing a first process medium with respect to a second chamber containing a second process medium that is different from the first process medium.
